(19) United States
(12) Patent Application Publication
(10) Pub. No.: US 2023/0359949 A1
(43) Pub. Date: Nov. 9, 2023

(54) RECOVERY SUPPORT APPARATUS, RECOVERY SUPPORT METHOD, AND PROGRAM

(71) Applicant: NIPPON TELEGRAPH AND TELEPHONE CORPORATION, Tokyo (JP)

(72) Inventors: Shohei NISHIKAWA, Musashino-shi, Tokyo (JP); Shunsuke KANAI, Musashino-shi, Tokyo (JP); Satoshi SUZUKI, Musashino-shi, Tokyo (JP); Chao WU, Musashino-shi, Tokyo (JP); Manami OGAWA, Musashino-shi, Tokyo (JP); Kazuaki AKASHI, Musashino-shi, Tokyo (JP); Naomi MURATA, Musashino-shi, Tokyo (JP)

(73) Assignee: NIPPON TELEGRAPH AND TELEPHONE CORPORATION, Tokyo (JP)

(21) Appl. No.: 18/027,258

(22) PCT Filed: Sep. 25, 2020
(86) PCT No.: PCT/JP2020/036409

§ 371 Date: Mar. 20, 2023

(51) Int. Cl. G06Q 10/047

(52) U.S. Cl. CPC G06Q 10/047

(57) ABSTRACT

A recovery assistance device according to an embodiment includes an analysis unit and a learning unit. The analysis unit generates a first procedure plan related to recovery work of a first failure by solving an optimization problem on the basis of first information related to the first failure. The learning unit acquires feedback information related to work procedure adopted for the recovery work of the first failure and generates a learning result reflecting the feedback information with respect to the first procedure plan. In a case where a second failure occurs, the analysis unit further generates a second procedure plan related to recovery work of the second failure using the learning result.

### TECHNICAL FIELD

Embodiments described herein relate generally to a recovery assistance device, a recovery assistance method, and a program.

### BACKGROUND ART

If a disaster occurs, recovery work of damaged facilities, and the like, is often required. For example, when a power failure occurs, it is necessary to perform work such as deployment of power supply vehicles and restoration of cables.

In related art, when a disaster occurs, analysis necessary for recovery work is manually performed on the basis of information regarding facilities to be recovered, information regarding the disaster, and the like. A target of such analysis includes, for example, priority, a deployment order, and the like.

A result of the analysis is presented to a manager of the recovery work, or the like. For example, the manager, or the like, of the recovery work determines a recovery order, or the like, on the basis of the presented analysis result and performs the recovery work. Then, after recovery from a disaster (recovery), know-how is stored through a review meeting, and the like, feedback on analysis procedure and analysis viewpoints is performed, and the feedback is utilized at the time of the next disaster.

As an example of a related technique, a technique for specifying a failure site occurring in a network on the basis of an alarm from a network failure monitoring system has been proposed (see Patent Literature 1). In addition, a technique for generating a rule capable of determining a failure cause location is also known (see Patent Literature 2).

### CITATION LIST

### Patent Literature

Patent Literature 1: JP 2007-124057 A

Patent Literature 2: JP 2018-028778 A

### SUMMARY OF INVENTION

### Technical Problem

However, many problems remain in analysis of recovery work.

Analysis of recovery work in related art is generally performed manually, time-consuming, and in some cases even difficult. In addition, the analysis is manually performed, and thus, the analysis result depends on skills and know-how of a person who is an analyst. Furthermore, an analysis viewpoint varies depending on the analyst, and thus, a quantitative effect cannot be exhibited, for example, a criterion of output is not clear. It is therefore difficult to explain to a final decision maker, and it is also difficult for the decision maker to make a decision because of an unclear criterion.

In a similar manner, feedback is also manually reflected in analysis procedure, which leaves many problems. First, it takes time to consider how to reflect the feedback in the analysis procedure. The reflection in the analysis procedure also depends on skills and know-how of a person. In addition, operation in new analysis procedure after the feedback is reflected also depends on skills of a person, and it takes time to entrench the new analysis procedure.

The present invention has been made in view of the above circumstances, and an object thereof is to provide a recovery assistance technique capable of generating a work procedure plan for recovery work in a shorter period of time and with more stable quality.

### Solution to Problem

In order to solve the above problem, a first aspect of the present invention is a recovery assistance device including: an analysis unit configured to generate a first procedure plan related to a recovery work of a first failure by solving an optimization problem on the basis of first information related to the first failure; and a learning unit configured to acquire feedback information related to work procedure adopted for the recovery work of the first failure and generate a learning result reflecting the feedback information with respect to the first procedure plan, in which in a case where a second failure occurs, the analysis unit generates a second procedure plan related to recovery work of the second failure using the learning result.

### Advantageous Effects of Invention

According to one aspect of the present invention, a recovery assistance device includes an analysis unit and a learning unit. The analysis unit generates a first procedure plan related to recovery work of a first failure by solving an optimization problem on the basis of information related to the first failure, and the learning unit generates a learning result reflecting feedback information with respect to the first procedure plan. In a case where a second failure occurs, the analysis unit further generates a second procedure plan related to recovery work of the second failure using the learning result.

As described above, according to one aspect of the invention, a work procedure plan is automatically generated on the basis of information related to a failure and feedback is automatically reflected, so that it is possible to provide an analysis result with stable quality that does not depend on skills or know-how of an analyst while shortening a necessary period of time. Furthermore, in a case where a new failure occurs, a procedure plan of recovery work is generated by utilizing the past learning result, so that a period of time required for generating the work procedure plan can be further shortened.

In other words, according to one aspect of the present invention, it is possible to provide a recovery assistance technique capable of generating a work procedure plan for recovery work in a shorter period of time and with more stable quality.

### BRIEF DESCRIPTION OF DRAWINGS

FIG. 1 is a view illustrating an example of an embodiment of the present invention.

FIG. 2 is a view illustrating an example of a functional configuration of a recovery assistance device according to an embodiment of the present invention.

FIG. 3 is a block diagram illustrating an example of a hardware configuration of the recovery assistance device according to an embodiment of the present invention.

FIG. 4 is a flowchart illustrating an example of analysis processing by the recovery assistance device illustrated in FIG. 2.

FIG. 5 is a flowchart illustrating an example of learning processing by the recovery assistance device illustrated in FIG. 2.

FIG. 6 is a view illustrating an example of analysis processing.

FIG. 7 is a view illustrating an embodiment of learning processing.

### DESCRIPTION OF EMBODIMENTS

Embodiments according to the present invention will be described below with reference to the drawings. Note that, hereinafter, the same or similar reference numerals will be given to the same or similar components as those already described, and redundant description will be basically omitted. For example, in a case where there are a plurality of same or similar components, a common reference numeral may be used to describe each component without distinguishing the components, or a branch number may be used in addition to the common reference numeral to distinguish and describe each component.

### First Embodiment

### (1) Outline

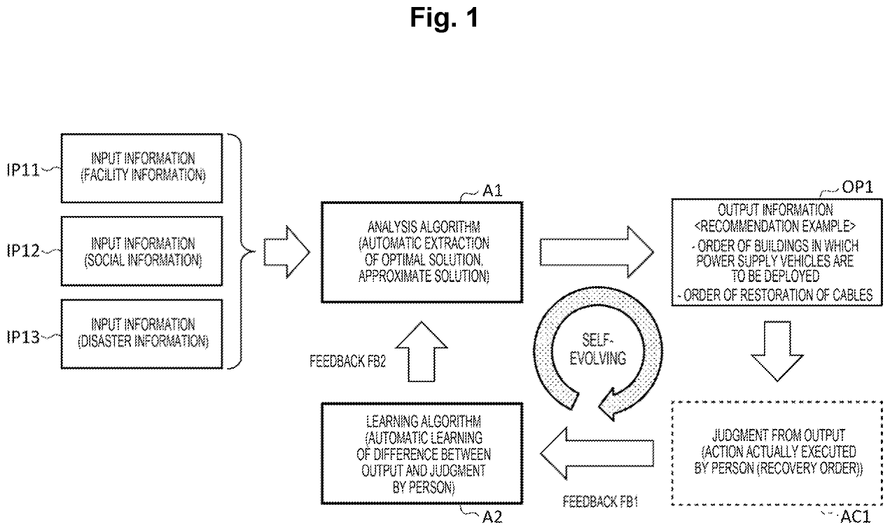

FIG. 1 illustrates outline of a recovery assistance technique according to an embodiment of the present invention.

As illustrated in FIG. 1, a recovery assistance technique according to an embodiment includes an analysis algorithm A1 and a learning algorithm A2, and autonomously evolves by cooperation of the analysis algorithm A1 and the learning algorithm A2.

First, in a case where a disaster or a failure occurs, the analysis algorithm A1 acquires information related to the disaster or the failure as input information IP11 to IP13. The input information IP11 to IP13 are input by, for example, a recovery work manager, a responsible person, or a decision maker (hereinafter, simply referred to as a “user”), and in this example, include facility information IP11, social information IP12, and disaster information IP13.

The facility information IP11 is information regarding a facility requiring recovery work and can include, for example, location information of the facility (for example, latitude and longitude), floor information of the facility (for example, the number of floors of a multi-story building, a positional relationship between stairs or elevators, and availability), disaster prevention information of the facility (for example, presence or absence of a firewall or a fireproof wall, and earthquake resistance), and the like. The social information IP12 can include information on a social environment related to a point at which recovery work is required, for example, traffic-related information (traffic jam information, traffic restriction information such as construction, road closure and lane change) related to a movement path to a failure point. The disaster information IP13 is information indicating content or a type of a failure or a disaster and includes, for example, power failure information of a facility building in which recovery work is required.

The analysis algorithm A1 solves an optimization problem on the basis of the acquired input information IP11 to IP13 and automatically extracts an optimum solution or an approximate solution, thereby generating a procedure plan (hereinafter, also referred to as “recommendation information”) of recovery work.

The recommendation information generated by the analysis algorithm A1 is output as output information OP1 and is presented to the user via, for example, a display device (not illustrated), or the like. Examples of the recommendation information to be presented include an order of buildings in which power supply vehicles are to be deployed, an order of restoration of cables, and the like.

The user determines actual work procedure (recovery order) on the basis of the presented output information OP1 and acts (AC1). The work procedure (AC1) actually adopted for the recovery work may be the same as or different from the output information OP1. For example, in a case where part of a movement path presented by the output information OP1 is inaccessible due to a sudden accident, a different movement path is adopted in the actual recovery work. In this way, in a case where the output information OP1 is different from the actual work procedure AC1, for example, information regarding an inaccessible path is input to the learning algorithm A2 as feedback FB1. The feedback FB1 can be input as, for example, information that “this path was inaccessible” by manual work of the user. Alternatively, the feedback FB1 may be automatically input by a tool (application program), or the like, that detects a difference between the output information OP and the actual work procedure AC1.

The learning algorithm A2 acquires the feedback FB1, determines a difference between the output information OP1 and the actual work procedure AC1 and performs automatic learning. In other words, the learning algorithm A2 generates a learning result reflecting the feedback FB1 with respect to the output information OP1. The generated learning result is further fed back to the analysis algorithm A1 as feedback FB2. The analysis algorithm A1 can utilize the learning result by the learning algorithm A2 when generating a new procedure plan.

As described above, according to one embodiment, a series of recovery work including (i) analysis of a coping method, (ii) execution, (iii) reflection of an execution result, and (iv) next analysis . . . are made an algorithm so that (I) analysis, (II) learning, and (III) next analysis . . . can be autonomously performed, thereby shortening a period of time to recovery from a disaster. In addition, it is possible to systematize and level recovery work without depending on know-how of a person.

Note that in the present specification, a “disaster” refers to an overall situation in which damage occurs due to a natural phenomenon, an accident, or the like. In addition, in the present specification, a “failure” refers to all events that require recovery work and can include events involving a wide range of damage targets such as a power failure, a communication failure, a network failure, and a system failure, as well as damage, failure, and other abnormalities of individual devices or facilities. However, in the present specification, the terms disaster and failure are not used in a strict distinction and may be used interchangeably. Thus, “recovery from a disaster” can also be replaced by “recovery from a failure” and refers to returning to a normal or equivalent state prior to occurrence of the disaster or the failure.

### (2) Configuration

### (2-1) Functional Configuration

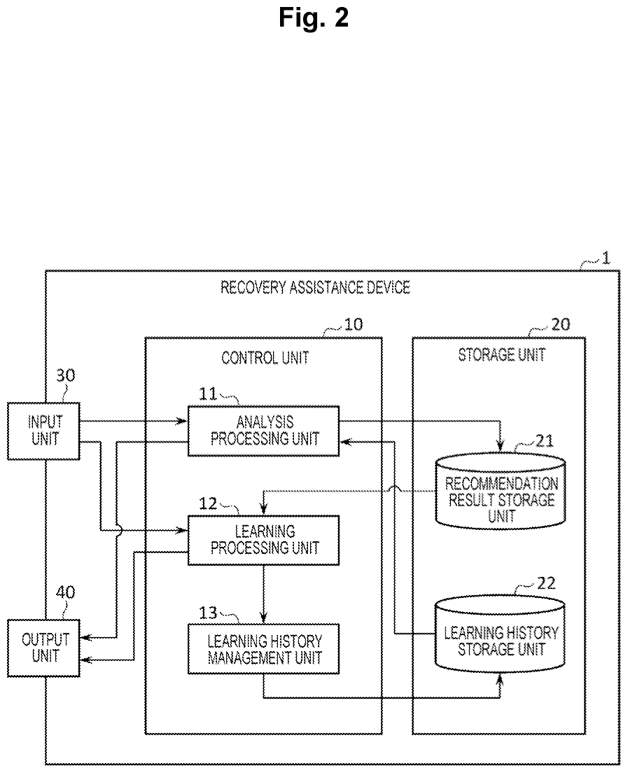

FIG. 2 is a view illustrating an example of a functional configuration of a recovery assistance device 1 according to an embodiment of the present invention. The recovery assistance device 1 is a computer capable of executing the analysis algorithm and the learning algorithm as described above and can be, for example, a personal computer or a server computer.

The recovery assistance device 1 according to one embodiment includes a control unit 10, a storage unit 20, an input unit 30, and an output unit 40.

The input unit 30 receives information related to a disaster or a failure requiring recovery work as input information and performs processing of passing the information to the control unit 10. As described above, the input information can include facility information, social information, and disaster information. However, the information is not limited thereto and may include other information or may be replaced with other information. The input unit 30 receives the input information as information input by the user, or the like, via an input device such as a keyboard. Alternatively, the input unit 30 can acquire the information from other devices connected via a network or from an external memory such as a USB memory.

The output unit 40 performs processing of outputting output data generated by the control unit 10 of the recovery assistance device 1. The output unit 40 presents the output data to the user by an output device such as a display. Alternatively, for example, the output unit 40 can also output a procedure plan generated by the recovery assistance device 1 as a data file to an external memory or to other devices connected via a communication network.

The storage unit 20 has a function of storing information to be used or to be generated in the process of processing by the recovery assistance device 1 and in this example, includes a recommendation result storage unit 21 and a learning history storage unit 22.

The recommendation result storage unit 21 stores recommendation information as a procedure plan of recovery work to be calculated by the analysis processing unit 11. The recommendation information can include a procedure plan calculated by solving the optimization problem by the analysis processing unit 11, for example, information indicating a movement path to a failure location, an order of buildings in which power supply vehicles are to be deployed, an order of restoration of cables, and the like.

The learning history storage unit 22 is managed by the learning history management unit 13 and stores a learning result by the learning processing unit 12. The learning result in which actual work procedure is reflected in the corresponding recommendation information, is stored in association with the input information used when the recommendation information is calculated.

The recommendation result storage unit 21 and the learning history storage unit 22 are not necessarily provided in the recovery assistance device 1 and may be replaced with an external database, or the like.

The control unit 10 has a function of controlling the entire operation of the recovery assistance device 1 and includes the analysis processing unit 11, the learning processing unit 12, and the learning history management unit 13.

The analysis processing unit 11 functions as an analysis unit and solves an optimization problem on the basis of the acquired input information to generate a procedure plan related to recovery work of a failure. When a new failure occurs, the analysis processing unit 11 also searches the learning history storage unit 22 for presence or absence of a corresponding learning result on the basis of input information related to the new failure, reads the corresponding learning result in a case where there is the corresponding learning result and uses the past learning result as a procedure plan for recovery work of the new failure. The analysis processing unit 11 outputs the procedure plan to the output unit 40 or causes the procedure plan to be stored in the recommendation result storage unit 21 as recommendation information. The processing of the analysis processing unit 11 will be further described later.

The learning processing unit 12 functions as a learning unit, acquires feedback information related to work procedure actually adopted in the recovery work of the failure and generates a learning result in which the feedback information is reflected in the recommendation information. The feedback information includes, for example, information on an inaccessible road. The feedback information can also include information (for example, date and time of occurrence of a disaster or a failure, identification name of the disaster or the failure, location information of a point where recovery work is required (a location where the failure has occurred), date and time when the recommendation information has been output, or the like) that can identify a corresponding failure or corresponding recommendation information. The learning processing unit 12 reads the recommendation information corresponding to the feedback information from the recommendation result storage unit 21 on the basis of the acquired feedback information and generates a learning result reflecting the feedback information. The learning processing unit 12 outputs the learning result to the output unit 40. The learning processing unit 12 also outputs a learning result to the learning history management unit 13. The processing of the learning processing unit 12 will be further described later.

The learning history management unit 13 causes the learning result received from the learning processing unit 12 to be stored in the learning history storage unit 22 in association with the corresponding input information.

### (2-2) Hardware Configuration

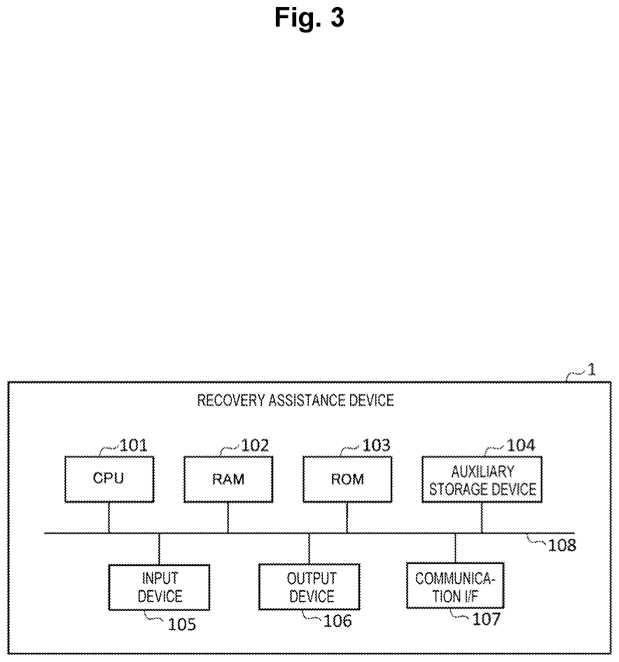

FIG. 3 is a block diagram illustrating an example of a hardware configuration of the recovery assistance device 1. The recovery assistance device 1 includes a central processing unit (CPU) 101, a random access memory (RAM) 102, a read only memory (ROM) 103, an auxiliary storage device 104, an input device 105, an output device 106, and a communication interface (communication I/F) 107, which are connected to each other via a bus 108.

The CPU 101, which is an example of a processor, controls the overall operation of the recovery assistance device 1. The CPU 101 can operate as the analysis processing unit 11, the learning processing unit 12, and the learning history management unit 13 described above by loading a program stored in the ROM 103 or the auxiliary storage device 104 to the RAM 102 and executing the program. The CPU 101 may be implemented in various other formats including an integrated circuit such as an application specific integrated circuit (ASIC) and a field-programmable gate array (FPGA). In addition, the CPU 101 may include a plurality of processors.

The auxiliary storage device 104 can be, for example, a hard disk drive (HDD) or a solid state drive (SDD). The auxiliary storage device 104 non-temporarily stores a program to be executed by the CPU 101, configuration data necessary for executing the program, and the like. The auxiliary storage device 104 can also function as a storage unit including the recommendation result storage unit 21 and the learning history storage unit 22 described above.

The input device 105 includes, for example, a keyboard, or the like, to be used by the user to input an instruction to the recovery support device 1. Furthermore, the input device 105 can include a reader for reading data to be stored in the storage unit 20 from a memory medium such as a USB memory, and a disk device for reading the data from a disk medium. Furthermore, the input device 105 may include an image scanner with or without an optical character recognition (OCR) function.

The output device 106 includes a display that displays output data to be presented from the recovery assistance device 1 to the user, or the like, a printer that prints the output data, and the like. Furthermore, the output device 106 may include a writer for writing data to be input to other information processing devices such as a personal computer and a smartphone to a memory medium such as a USB memory, and a disk device for writing such data to a disk medium.

The communication interface 107 is, for example, an interface for wireless or wired local area network (LAN) communication. The recovery assistance device 1 can, for example, read information from an external database or transmit the generated procedure plan to an external device via a network such as the Internet by the communication interface 107.

However, the above description is merely an example, and a specific hardware configuration of the recovery assistance device 1 may be appropriately omitted, replaced, or added according to the embodiment.

### (3) Operation

Next, information processing operation by the recovery assistance device 1 configured as described above will be described.

The operation by the recovery assistance device 1 includes analysis processing operation by the analysis processing unit 11 and learning processing operation by the learning processing unit 12.

### (3-1) Analysis Processing

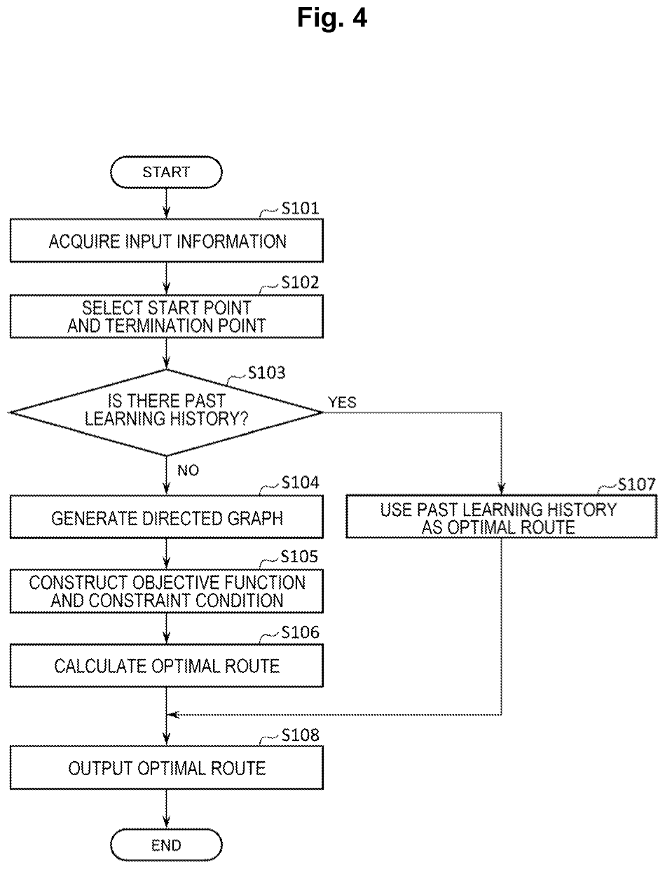

FIG. 4 is a flowchart illustrating procedure and content of the analysis processing operation by the analysis processing unit 11. For example, if the control unit 10 receives input of input information via the input unit 30, the control unit 10 causes the analysis processing unit 11 to start the following analysis processing operation.

First, in step S101, the analysis processing unit 11 acquires the input information. The input information can include facility information, social information, and disaster information.

In step S102, the analysis processing unit 11 performs processing of selecting a start point and a termination point. The start point may be defined in advance or may be arbitrarily designated by the user each time analysis is performed. For example, the start point can be a base building of recovery work. The termination point is selected on the basis of the input information. For example, the termination point can be a point where a failure has occurred (failure location) determined from the facility information in the input information.

In step S103, the analysis processing unit 11 determines presence or absence of an available past learning history. A determination condition may be arbitrarily set by the user, or the like. For example, the analysis processing unit 11 searches the learning history storage unit 22 for past data having the same conditions such as input information to be used, a start point, a termination point, and content of a failure. In a case where there is no past learning history (No), the processing proceeds to step S104, and an optimal route is searched from step S104 to step S106. On the other hand, in a case where there is a past learning history (Yes), the learning history is read, and the processing proceeds to step S107.

In step S104, the analysis processing unit 11 generates a directed graph including the start point, the termination point, a branch point therebetween, and the like, as vertices (nodes) on the basis of the input information. Each branch between vertices corresponds to procedure that can be taken, and weight of each branch is automatically set in accordance with a moving distance, a required period of time, a required fee, and the like. Alternatively, the user may arbitrarily set the weight.

In step S105, the analysis processing unit 11 constructs an objective function and a constraint condition for setting an optimization problem. The objective function and the constraint condition can be automatically set in accordance with a type of the disaster, purpose of recovery, and the like, or can be set by the user.

In step S106, the analysis processing unit 11 calculates an optimal route by solving the optimization problem on the basis of the directed graph, the objective function, and the constraint condition. An example of calculation of the optimal route will be described later.

On the other hand, in a case where there is a past learning history, the analysis processing unit 11 uses the read past learning history as the optimal route in step S107. This can shorten a period of time required for the analysis processing and make the calculation processing efficient.

Next, in step S108, the analysis processing unit 11 outputs the read optimal route as the past learning history or the calculated optimal route to the output unit 40 or the recommendation result storage unit 21.

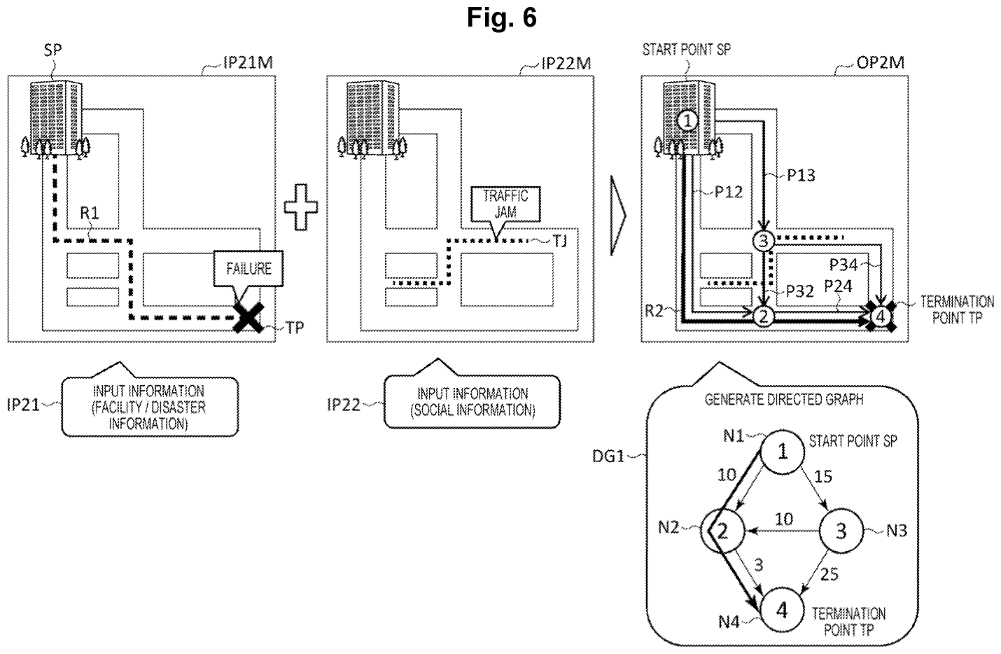

FIG. 6 is a view illustrating an example of optimal solution calculation processing by the analysis processing unit 11.

Here, as the “recovery work”, “movement to a failure location” will be described as an example. In the following processing, it is assumed that the control unit 10 can use map data including location information such as latitude and longitude and road information in advance.

A map IP21M on a left side indicates input information (facility information and disaster information) IP21 drawn on a map. As an example, the facility information includes location information of the failure location TP as the termination point. The disaster information includes power failure information as an example. It is assumed that a position of the base building SP as a start point is input in advance. A route R1 indicates an example of a route that can be used to move from the base building SP to the failure location TP.

A map IP22M at the center indicates the input information (social information) IP22 on the map. The social information includes traffic jam information as an example. Here, information TJ on a road on which the traffic jam has occurred is selected. The social information can include other traffic restriction information such as construction information, road closure information, lane change information, and the like.

A map OP2M on the right side indicates output information based on the recommendation information calculated on the basis of the input information IP21 and the input information IP22, drawn on the map. More specifically, the analysis processing unit 11 generates a directed graph DG1 based on the input information IP21 and IP2 and calculates recommendation information by solving an optimization problem. The recommendation information is calculated as, for example, an optimal solution to a shortest path problem. The directed graph DG1 includes a vertex 1 (N1) as a start point SP, a vertex 4 (N4) as a termination point TP, and an intermediate vertex 2 (N2) and an intermediate vertex 3 (N3). Paths P12, P13, P32, P24, and P34 between the vertices drawn on the map OP2M correspond to edges between the vertices of the directed graph.

The optimal solution is obtained as a solution that minimizes the objective function as follows, for example.

Main problem: a route that allows the user to reach the failure location at the fastest is obtained.

Objective function: 10x₁₂+15x₁₃+10x₃₂+3x₂₄+25x₃₄

### Constraint conditions:

xₙ+x₁₃=1 (C1)

x₁₃=x₃₂+x₃₄ (C2)

x₁₂+x₃₂=x₂₄ (C3)

x₃₄+x₂₄=1 (C4)
where x₁₂, x₁₃, x₃₂, x₂₄, x₃₄≥0

xᵢⱼ∈{0, 1}; xᵢⱼ=1 in a case of passing through a branch (i, j), xᵢⱼ=0 in a case of not passing through the branch (i, j).

The traffic jam information TJ can be reflected in the constraint condition. For example, in a case where the path P32 from the vertex 3 to the vertex 2 is congested, X₃₂=0 is added to the constraint condition. A coefficient (weight) of each term of the objective function is merely an example and may be automatically set or arbitrarily set by the user, or the like, in accordance with a distance between points related to the edge (i, j), a required period of time, a fee, and the like.

In the above example, the optimal solution that minimizes the objective function=13 is obtained. In this event,
x₁₂=1, x₁₃=0, x₃₂=0, x₂₄=1, x₃₄=0, and
x₁₂=1 and x₂₄=1, and thus, a route R2 reflecting the optimal solution is a route of vertex 1 (start point)→vertex 2→vertex 4 (termination point).

The analysis processing unit 11 generates recommendation information by using the obtained information on the optimal route R2 and outputs the recommendation information to the output unit 40 and the recommendation result storage unit 21. For example, the recommendation information is presented to the user by a display, or the like, as the output information OP2M.

### (3-2) Learning Processing

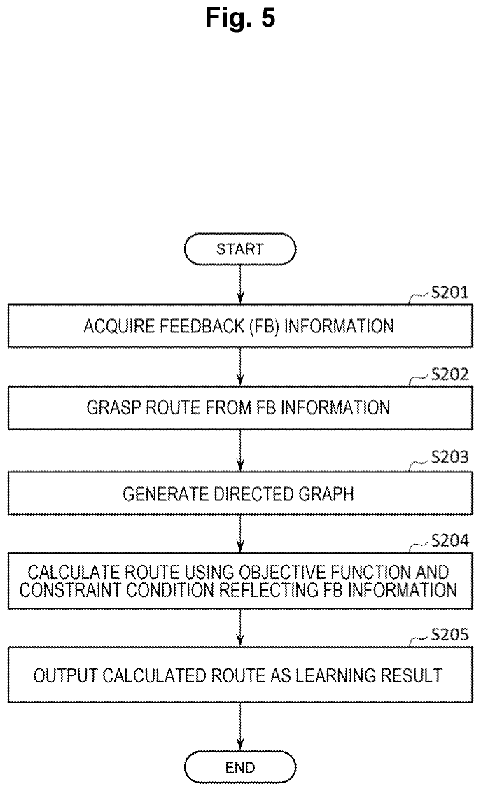

FIG. 5 is a flowchart illustrating procedure and content of learning processing operation by the learning processing unit 12. For example, if the control unit 10 receives input of the feedback information via the input unit 30, the control unit 10 causes the learning processing unit 12 to start the following learning processing operation.

In step S201, the learning processing unit 12 acquires the input feedback (FB) information. The feedback information can include, for example, information that a specific road is inaccessible. The feedback information further includes information (for example, date and time information) for specifying which recommendation information or which failure the feedback information corresponds to.

In step S202, the learning processing unit 12 grasps the route from the feedback information.

In step S203, the learning processing unit 12 reads the recommendation information corresponding to the feedback information from the recommendation result storage unit 21 and generates a directed graph again on the basis of the read recommendation information or feedback information.

In step S204, the learning processing unit 12 recalculates an optimal route using the objective function reflecting the feedback information and the constraint condition. For example, in a case where the feedback information indicates an inaccessible road, the learning processing unit 12 can reflect the feedback information in the constraint condition.

In step S205, the learning processing unit 12 outputs the recalculated route to the output unit 40 or the learning history management unit 13 as a learning result.

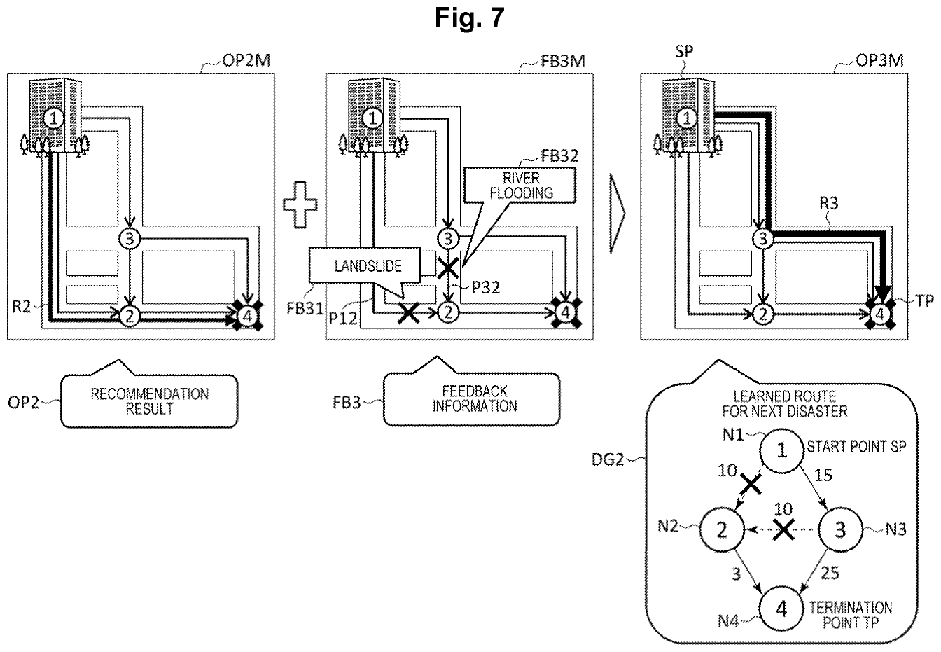

FIG. 7 is a view illustrating an example of processing by the learning processing unit 12.

Similarly to FIG. 6, “movement to the failure location” will be described as an example of the “recovery work”. It is also assumed that the control unit 10 can use map data including location information such as latitude and longitude and road information in advance.

The map OP2M on the left side indicates the read recommendation result OP2 drawn on the map. In this example, the map OP2M on the left side in FIG. 7 is the same as the map OP2M on the right side in FIG. 6, and the optimal route R2 obtained by the analysis processing in FIG. 6 is drawn.

A map FB3M at the center indicates feedback information FB3 drawn on the map. As an example, the feedback information FB3 includes information FB31 of “landslide in a path P12” and information FB32 of “river flooding in a path P32”. The feedback information FB3 may be input by the user as described above or may be read by accessing an external database that manages road traffic information, for example.

A map OP3M on the right side indicates a learning result reflecting the feedback information FB3 on the recommendation result OP2, drawn on the map. The learning processing unit 12 generates a directed graph DG2 on the basis of the recommendation information OP2 and the feedback information FB3, resets the objective function and the constraint condition and obtains the optimal solution again. Similarly to the directed graph DG1 illustrated in FIG. 6, the directed graph DG2 includes a vertex 1 (N1) as a start point SP, a vertex 4 (N4) as a termination point TP, and an intermediate vertex 2 (N2) and an intermediate vertex 3 (N3). In this example, in the directed graph DG2, the weight of each branch is the same as that of the directed graph DG1 illustrated in FIG. 6, but unavailable paths based on the feedback information FB3 are reflected by cross marks.

The optimal solution is obtained as a solution that minimizes the objective function as follows, for example.

Main problem: a route that allows the user to reach the failure location at the fastest is obtained.

Objective function: 10x₁₂+15x₁₃+10x₃₂+3x₂₄+25x₃₄

Constraint conditions:

x₁₂+x₁₃=1 (C1)

x₁₃=x₃₂+x₃₄ (C2)

x₁₂+x₃₂=x₂₄ (C3)

x₃₄+x₂₄=1 (C4)

x₁₂=0,x₃₂=0 (C5)
where x₁₂, x₁₃, x₃₂, x₂₄, x₃₄≥0

xᵢⱼ∈{0, 1}; xᵢⱼ=1 in a case of passing through a branch (i, j), xᵢⱼ=0 in a case of not passing through the branch (i, j).

In this example, the main problem and the objective function are the same as those used in the analysis processing, but a constraint condition (C5) is added on the basis of the feedback information FB3.

In this example, the optimal solution that minimizes the objective function=40 is obtained. In this event,
x₁₂=0, x₁₃=1, x₃₂=0, x₂₄=0, x₃₄=1
x₁₃=1 and x₃₄=1, and thus, a route R3 after learning reflecting the optimal solution is a route of the vertex 1 (start point)→the vertex 3→the vertex 4 (termination point).

The learning processing unit 12 outputs the obtained information on the route R3 to the output unit 40 as a learning result or passes the information on the route R3 to the learning history management unit 13 to cause the information to be stored in the learning history storage unit 22. This learning result is a learning route for the next disaster.

The optimization problem to be used by the analysis processing unit 11 and the learning processing unit 12 is not limited to the shortest path problem described above as an example and may be appropriately selected in accordance with a type of a disaster or a failure, purpose of recovery work, and the like.

### (4) Effects

As described above in detail, the recovery assistance device 1 according to an embodiment of the present invention includes the analysis processing unit 11 as an analysis unit and the learning processing unit 12 as a learning unit. The analysis processing unit 11 solves an optimization problem on the basis of input information as first information related to a first failure, thereby generating a first procedure plan related to recovery work of the first failure. The learning processing unit 12 acquires feedback information related to work procedure adopted for the recovery work of the first failure and generates a learning result reflecting feedback information with respect to the first procedure plan. In a case where a second failure occurs, the analysis processing unit 11 can further generate a second procedure plan related to recovery work of the second failure using the learning result.

By the operation of the analysis processing unit 11, a stable procedure plan that does not depend on skills and know-how of an analyst can be obtained, and a period of time required for analysis can be shortened by utilizing the past learning results. In addition, the feedback information is automatically reflected on the procedure plan by the operation of the learning processing unit 12, and a stable learning result that does not depend on skills and know-how of the analyst can be generated.

The learning result is stored in the learning history storage unit 22 in association with the input information, and the analysis processing unit 11 can read the learning result that can be used from the learning history storage unit 22 on the basis of the input information. The analysis processing unit 11 can generate a first procedure plan by generating a directed graph and obtaining an optimal solution. The analysis processing unit 11 can also set a constraint condition on the basis of traffic-related information related to a movement path to a failure location to obtain an optimal solution. The learning processing unit 12 can obtain a learning result in which the feedback information is reflected in the first procedure plan by setting an additional constraint condition based on the feedback information and recalculating the optimal solution. This makes it possible to generate a more reliable procedure plan in a shorter period of time.

As described above, the recovery assistance device 1 according to an embodiment analyzes a method for coping with occurrence of a disaster, outputs recommendation information and performs learning based on judgment by a person for the recommendation information. At the time of occurrence of the next disaster, it is determined whether or not there is a learning result under the same condition, and if there is a corresponding learning result, the learning result can be utilized. As analysis of coping methods and learning results are accumulated, there are more cases where learning results reflecting judgment by a person can be utilized. As a result, the processing can be further simplified, so that disaster recovery work can be speeded up. In addition, know-how related to recovery work is systematized, so that the recovery work can be leveled.

### Other Embodiments

Note that the present invention is not limited to the above-described embodiments.

For example, the recovery assistance device 1 is not limited only to use of assisting recovery work at the time of occurrence of a disaster and can be applied to other uses in which a work procedure plan necessary for an event requiring some work is generated, a learning result reflecting an actually performed work is generated, and a past learning result can be used at the time of occurrence of a new event. For example, the present invention may be applied to generation of an inspection procedure plan when a network failure occurs. Similarly, an optimization target in an analysis algorithm and a learning algorithm is not limited to only a movement path and may be optimization of work procedure that does not involve geographical movement or may be optimization of arrangement procedure of people, physical, or financial resources. Similarly, each vertex of the directed graph is not limited to a geographical position and may represent process or various resources.

In addition, the functional units 11 to 13 included in the recovery assistance device 1 described above may be dispersedly arranged in a plurality of devices, and these devices may cooperate with each other to perform processing. Each functional unit may be implemented using a circuit. The circuit may be a dedicated circuit that implements a specific function or may be a general-purpose circuit such as a processor.

Furthermore, flow of each processing described above is not limited to the described procedure, and an order of some steps may be changed, or some steps may be performed simultaneously in parallel. Furthermore, a series of processing described above does not need to be executed temporally continuously, and each step may be executed at an arbitrary timing.

The device according to the embodiments of the present invention can also be implemented by a computer and a program, and the program can be recorded in a recording medium or provided through a network. For example, the method described in the embodiments can be stored as a program (software) that can be executed by a computer, for example, in a recording medium such as a magnetic disk (such as a hard disk), an optical disk (such as a CD-ROM and a DVD), or a semiconductor memory (such as a ROM, a RAM and a flash memory) or can be distributed by being transmitted through a communication medium. Note that the program stored on the medium side also includes a configuration program that causes software (including not only an execution program but also a table and a data structure) to be executed by the computer to be configured in the computer. A computer that implements the present device reads a program recorded in a recording medium, constructs software by a configuration program according to circumstances and executes the above-described processing by controlling operation by the software. Note that the recording medium in the present specification is not limited to a recording medium for distribution and includes a storage medium such as a magnetic disk and a semiconductor memory provided in equipment connected inside a computer or via a network.

In addition, the configuration of each storage unit, an input/output data format, and the like, can be variously modified and implemented without departing from the gist of the present invention.

In short, the present invention is not limited to the above-described embodiments, and various modifications can be made in the implementation stage without departing from the gist thereof. In addition, the embodiments may be implemented in appropriate combination, in which case, effects as a result of combination can be obtained. Furthermore, the above-described embodiments include various inventions, and various inventions can be extracted by a combination selected from a plurality of disclosed components. For example, even if some components are deleted from all the components described in the embodiments, if the problem can be solved and the effects can be obtained, the configuration from which the components are deleted can be extracted as the invention.

### REFERENCE SIGNS LIST

1 Recovery assistance device
10 Control unit
11 Analysis processing unit
12 Learning processing unit
13 Learning history management unit
20 Storage unit
21 Recommendation result storage unit
22 Learning history storage unit
30 Input unit
40 Output unit
101 CPU
102 RAM
103 ROM
104 Auxiliary storage device
105 Input device
106 Output device
107 Communication interface
108 Bus

1. A recovery assistance device comprising:
a processor; and
a storage medium having computer program instructions stored thereon, when executed by the processor, perform to:
generate a first procedure plan related to recovery work of a first failure by solving an optimization problem on a basis of first information related to the first failure; and
acquire feedback information related to work procedure adopted for the recovery work of the first failure and generate a learning result reflecting the feedback information with respect to the first procedure plan,
wherein in a case where a second failure occurs, generates a second procedure plan related to recovery work of the second failure using the learning result.

2. The recovery assistance device according to claim 1, wherein the computer program instructions further perform to reads a learning result to be used for the recovery work of the second failure from a storage unit that stores the learning result in association with the first information on a basis of comparison between the first information related to the first failure and second information related to the second failure and uses the read learning result as the second procedure plan.

3. The recovery assistance device according to claim 1, wherein the computer program instructions further perform to generates a directed graph on a basis of the first information and generates the first procedure plan by calculating a first optimal solution for the directed graph.

4. The recovery assistance device according to claim 3,
wherein the first information includes location information on a first point related to the recovery work of the first failure and information on a movement path to the first point, and
the computer program instructions further perform to generates the first procedure plan by solving a shortest path problem for moving to the first point on a basis of the directed graph.

5. The recovery assistance device according to claim 4,
wherein the first information further includes traffic-related information related to the movement path to the first point, and
the computer program instructions further perform to generates the first procedure plan by setting a first constraint condition based on the traffic-related information for the directed graph and solving the shortest path problem under the first constraint condition.

6. The recovery assistance device according to claim 5,
wherein the computer program instructions further perform to sets a second constraint condition to be applied to the directed graph on a basis of the feedback information and further uses a second optimal solution to be calculated from the directed graph under the second constraint condition as the learning result.

7. A recovery assistance method comprising:
generating a first procedure plan related to recovery work of a first failure by solving an optimization problem on a basis of first information related to the first failure;
acquiring feedback information related to work procedure adopted for the recovery work of the first failure and generating a learning result reflecting the feedback information with respect to the first procedure plan; and
generating, in a case where a second failure occurs, a second procedure plan related to recovery work of the second failure using the learning result.

8. A non-transitory computer-readable medium having computer executable instructions that, upon execution of the instructions by a processor of a computer, cause the computer to function as the device according to claim 1.
